(19) United States
(12) Patent Application Publication
(10) Pub. No.: US 2010/0323676 A1
(43) Pub. Date: Dec. 23, 2010

(54) METHOD, SYSTEMS, AND DEVICE FOR IMPLEMENTING COLOR RING BACK TONE SERVICE

(76) Inventors: Guojun Xu, Shenzhen (CN); Lingyan Wu, Shenzhen (CN); Lunjian Mu, Shenzhen (CN); Yuan Bao, Shenzhen (CN)

Correspondence Address: Huawei/BHGL, P.O. Box 10395, Chicago, IL, 60610, US

(21) Appl. No.: 12/869,513

(22) Filed: Aug. 26, 2010

Related U.S. Application Data
(63) Continuation of application No. PCT/CN2008/072744, filed on Oct. 17, 2008.

(30) Foreign Application Priority Data
Feb. 26, 2008 (CN) 200810007868.9

(51) Int. Cl. H04M 3/42

(52) U.S. Cl. 455/414.1

(57) ABSTRACT

A method for acquiring color ring back tone (CRBT) service information of a contact is provided. The method includes the following steps. A request message is sent to an information publishing server of a contact, so as to request to acquire personal information of the contact. The personal information of the contact sent from the information publishing server is received, in which the personal information includes CRBT service information of the contact. Thus, the converged address book (CAB) service can converge CRBT information set by a CAB user, so as to show whether the CAB user has subscribed to the CRBT service and show subscribed CRBTs to contacts subscribing to the personal information of the CAB user, and other users calling the CAB user can select and play CRBTs set by the CAB user.

### CROSS-REFERENCE TO RELATED APPLICATIONS

This application is a continuation of International Application No. PCT/CN2008/072744, filed on Oct. 17, 2008, which claims priority to Chinese Patent Application No. 200810007868.9, filed on Feb. 26, 2008, both of which are hereby incorporated by reference in their entireties.

### FIELD OF THE TECHNOLOGY

The present invention relates to the field of communication technology, and more particularly to a method, a system, and a device for implementing a color ring back tone (CRBT) service.

### BACKGROUND OF THE INVENTION

A CRBT service is a service that allows mobile phone users and fixed phone users to customize and show special ring back tones (RBTs) instead of conventional RBTs to users calling them. The RBTs customized by the phone users may be audio including music or pre-recorded voice information, or multimedia information including video, audio, or other media. CRBT service users may select by themselves RBT files provided by a service provider or operator through a user self-service platform on an Internet network or upload RBT files edited and made by themselves to the website and set a corresponding CRBT playing policy. When calling a user that has applied for the CRBT service, a calling user can see or hear RBT file information selected by the user instead of a conventional RBT. In addition, the CRBT service may be applied for and set by a called party and shown to users calling the called party, or applied for and set by a calling party and shown to the calling party when calling other users.

The existing converged address book (CAB) service stores static and dynamic personal information of each user for his contacts' subscription, and a CAB server and a terminal of the user also save static information and dynamic information of contacts to which the user subscribes. The static information includes different contact information of users, such as work phone numbers, home phone numbers, mobile phone numbers, and QQ numbers, and further includes personal homepages, home addresses, and work units. The dynamic information includes presence information and personal preferences including communication preferences and media type preferences. Meanwhile, the dynamic information also includes a part of personal service information, such as location information, service capabilities, and whether Instant Message (IM) or Push-to-talk Over Cellular (POC) is online.

The current CRBT service includes a calling CRBT service to which calling parties subscribe and a called CRBT service to which called parties subscribe. The current CRBT solution includes a circuit switch (CS) domain implementation solution and a packet switch (PS) domain implementation solution. The above CRBT solution includes an Internet Protocol (IP) Multimedia Subsystem (IMS) domain implementation solution. However, for the called CRBT service, a calling user is unaware of CRBTs set by a called user, and thus cannot select a CRBT played to him/her but passively experiencing a CRBT set by the called party and played to him/her.

In the implementation of the present invention, the inventors find that the prior art at least has the following problems.

The existing CAB service cannot converge CRBT service information set by users, so that the calling user cannot know whether the called user has subscribed to the CRBT service or subscribed CRBTs. Moreover, when the called user subscribes to multiple CRBTs, the calling user calling the called user cannot select the CRBT set by the called user but randomly hearing one of the multiple CRBTs of the called user.

### SUMMARY OF THE INVENTION

The present invention is directed to a method, a system, and a device for implementing a CRBT service, so as to realize an information showing service which converges CRBT information set by a user and shows whether the user has subscribed to the CRBT service and subscribed CRBTs to contacts subscribing to CRBT information of the user, and enable other users calling the user to select and play CRBTs set by the user when the user subscribes to multiple CRBTs.

To achieve the above objectives, in an embodiment, the present invention provides a method for acquiring CRBT service information of a contact, which includes the following steps:

A request message is sent to an information publishing server of a contact, so as to request to acquire personal information of the contact. The personal information of the contact sent from the information publishing server is received, in which the personal information includes CRBT service information of the contact.

In an embodiment, the present invention further provides a method for providing CRBT service information of a contact, which includes the following steps. An information publishing server receives a request message requesting to acquire personal information of a contact sent from a terminal. The information publishing server returns the personal information of the contact to the terminal, in which the personal information includes CRBT service information of the contact.

In an embodiment, the present invention further provides a method for playing a CRBT, which includes the following steps.

A CRBT service platform receives a call request, and determines whether the call request carries CRBT information. If the call request carries the CRBT information, the CRBT service platform plays a CRBT to a terminal initiating the call request according to the CRBT information.

In an embodiment, the present invention further provides a system for implementing a CRBT service, which includes a terminal and a CAB server. The terminal is configured to send a request message to the CAB server to request to acquire personal information of the contact, and receive the personal information of the contact sent from the CAB server. The personal information includes CRBT service information of the contact. The CAB server is configured to receive the request message sent from the terminal and send the personal information of the contact to the terminal.

In an embodiment, the present invention further provides a terminal, which includes a sending module and a receiving module. The sending module is configured to send a request message to a CAB server to request to acquire personal information of a contact. The receiving module is configured to receive the personal information of the contact sent from the CAB server, in which the personal information includes CRBT service information of the contact.

In an embodiment, the present invention further provides a CAB server, which includes a receiving module and a sending module. The receiving module is configured to receive a request message requesting to acquire personal information of a contact sent from a terminal. The sending module is configured to return the personal information of the contact to the terminal, in which the personal information includes CRBT service information of the contact.

In an embodiment, the present invention further provides a CRBT service platform, which includes a receiving module, a determining module, and a playing module. The receiving module is configured to receive a call request initiated by a terminal. The determining module is configured to determine whether the call request carries CRBT information. The playing module is configured to play a CRBT to the terminal according to a determination result of the determining module.

As compared with the prior art, the embodiments of the present invention have the following advantages. In the embodiments of the present invention, the CAB service can converge CRBT information set by a user, so as to show whether the user has subscribed to the CRBT service and the subscribed CRBTs to contacts subscribing to the personal information of the user, and other users calling the user can select and play CRBTs set by the user when the user subscribes to multiple CRBTs.

### BRIEF DESCRIPTION OF THE DRAWINGS

FIG. 1 is a general logical structural view of an embodiment of the present invention;

FIG. 2 is a logical structural view illustrating implementation of selecting and playing a CRBT by using a CAB according to an embodiment of the present invention;

FIG. 3 is a flow chart of a method for acquiring CRBT service information according to an embodiment of the present invention;

FIG. 4 is a flow chart of a method for selecting and playing a CRBT according to an embodiment of the present invention;

FIG. 5 is a flow chart of a method for selecting and playing an IMS CRBT according to an embodiment of the present invention;

FIG. 6 is a structural view of a terminal according to an embodiment of the present invention;

FIG. 7 is a structural view of a CAB server according to an embodiment of the present invention; and

FIG. 8 is a structural view of a CRBT service platform according to an embodiment of the present invention.

### DETAILED DESCRIPTION OF THE EMBODIMENTS

The specific implementations in embodiments of the present invention are described in detail below.

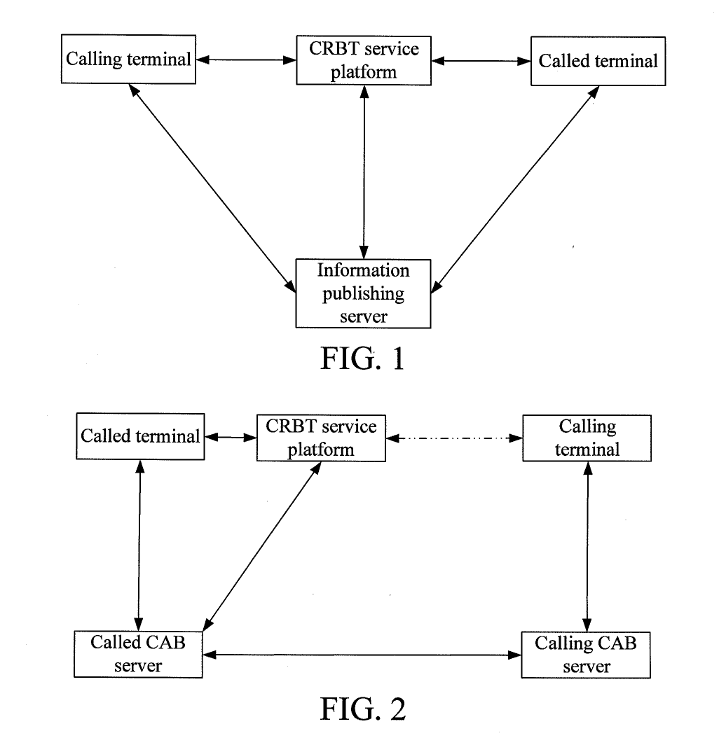

FIG. 1 is a general logical structural view of an embodiment of the present invention. In the embodiment of the present invention, a user can acquire related information of another user, including status information of the user and service-related information of the user through an information publishing server. In FIG. 1, a called user selects on a CRBT service platform CRBTs to be provided to a calling user for being selected and played, the CRBT service platform publishes the CRBTs to the information publishing server, the calling user subscribes to personal information of the called user from the information publishing server, in which the personal information includes CRBT service information for being selected and played, the information publishing server sends the personal information of the called user to a calling terminal, and when the calling terminal initiates a call to a called terminal, the calling user can select one from the CRBTs provided by the called user as a CRBT of the current call.

The information publishing server may be a Presence server or a CAB server. The embodiment of the present invention does not limit the specific method for acquiring CRBT information, and only gives detailed illustration in the following by taking the CAB server as an example.

FIG. 2 is a logical structural view illustrating implementation of selecting and playing a CRBT by using a CAB according to an embodiment of the present invention. A CAB server saves personal information and a network address book for a user. The network address book includes a contact list and a group list. The user can acquire personal information of each contact in a latest contact list, in which the personal information includes static information and dynamic information. A called CAB server acquires CRBT service information of a called user from a CRBT service platform, and converges the CRBT service information into personal information of the called user, such that a user setting the called user as a contact acquires the CRBT service information. When a calling user subscribes to the personal information of the called user, the called CAB server sends the personal information of the called user to a calling CAB server, and then to a calling terminal through the calling CAB server. When the personal information of the called user is changed, for example, when CRBT setting information thereof is changed, the called CAB server may notify the calling user and other contacts subscribing to the personal information of updated information. The interaction between the called terminal and the CRBT service platform may be implemented through the prior art, for example, a network service setting interface of the CRBT service platform. Regarding an interface between the called terminal and the CAB server, corresponding CRBT settings on the CAB server may be modified directly through an Extensible Markup Language Configuration Access Protocol (XCAP), and then the called CAB server updates CRBT settings of the CRBT service platform through an interface with the CRBT platform, or CRBTs may be set on the called terminal and then uploaded to the called CAB server. An interface protocol may be a Session Initiation Protocol (SIP) or Data Synchronization (DS) protocol. The interaction between the called CAB server and the CRBT service platform may be performed through the SIP protocol or the XCAP protocol.

Further, the called user may set a specific CRBT for an individual contact or group or all contacts thereof. The individually set CRBT information would be notified to a contact subscribing to the personal information of the called party, and if an update occurs, the updated CRBT information may also be further notified to the contact subscribing to the personal information of the called party.

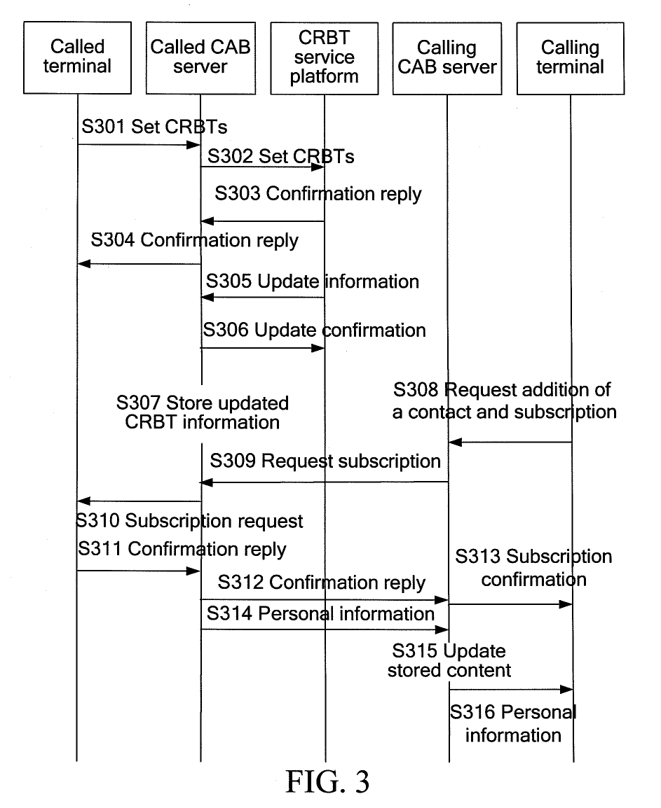

FIG. 3 is a flow chart of a method for acquiring CRBT service information according to an embodiment of the present invention. The method specifically includes the following steps.

In Steps S301-S304, a called user sets CRBT service information through a called terminal, and then sends the settings to a CRBT service platform through a called CAB server, and the CRBT service platform confirms the settings, or the called user sets the CRBT service information on the CRBT service platform directly through an existing approach.

In Steps S305-S307, when an information update occurs, the CRBT service platform sends the update of the CRBT service information to the called CAB server, or the called CAB server directly subscribes to the CRBT service information finally output by the CRBT service platform according to a policy change, and the called CAB server updates and stores the updated CRBT service information. The CRBT service information includes a CRBT policy set by the called terminal, for example, which CRBT starts from a certain time period.

In Steps S308-S314, a calling user adds the called user as a new contact, and the calling terminal sends a subscription request message to a calling CAB server. After the called CAB server receives the subscription request message sent from the calling terminal, if confirmation of the called user is required, the called CAB server sends a request message to the called terminal to request confirmation and inquire whether the subscription is approved, the called terminal returns a confirmation reply message to the calling terminal after confirming the subscription. Then the called CAB server sends personal information of the called user to the calling CAB server, in which the personal information includes the CRBT service information set by the called user.

In Steps S315-S316, the calling CAB server adds the personal information of the called user to a network address book of the calling user, stores the network address book in a storage module of the calling CAB server, and then sends updated personal address book information of the calling user to the calling terminal.

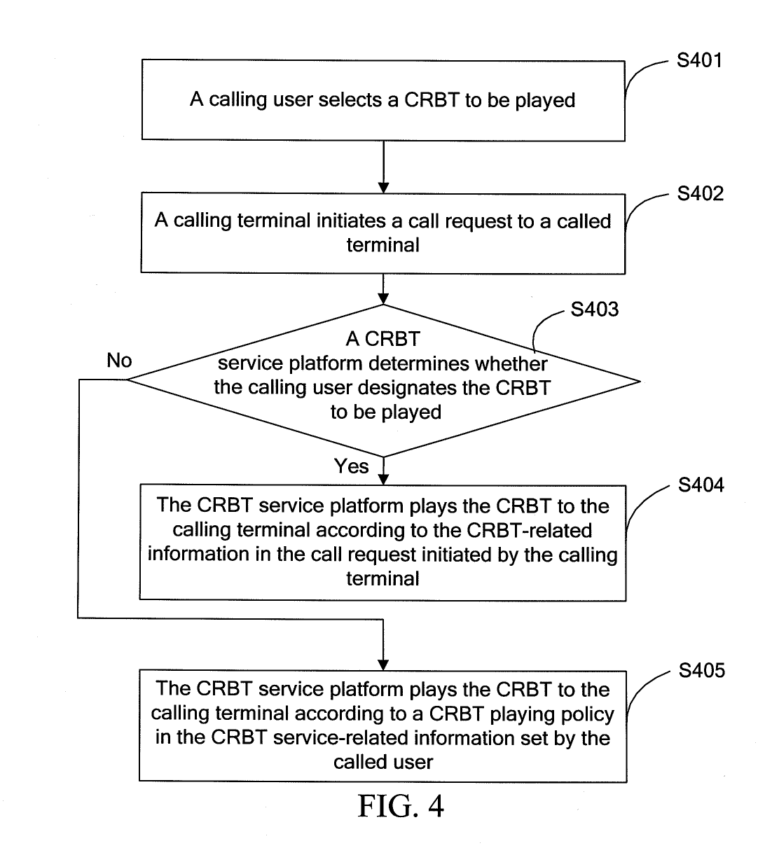

FIG. 4 is a flow chart of a method for selecting a CRBT according to an embodiment of the present invention. The method specifically includes the following steps.

In Step S401, a calling user selects a CRBT to be played. The calling user selects a CRBT desired by him/her from acquired CRBT service information set by a called user.

In Step S402, a calling terminal initiates a call request to a called terminal. The call request carries CRBT-related information selected by the calling user from the CRBT service information, and the related information includes an identification and a play mode of the CRBT.

In Step S403, a CRBT service platform determines whether the call request initiated by the calling terminal carries the CRBT-related information selected by the calling user from the CRBT service information, and if yes, performs Step S404; otherwise, performs Step S405.

In Step S404, the CRBT service platform plays the CRBT to the calling terminal according to the CRBT-related information in the call request initiated by the calling terminal.

In Step S405, the CRBT service platform plays the CRBT to the calling terminal according to a CRBT playing policy in the CRBT service information set by the called terminal.

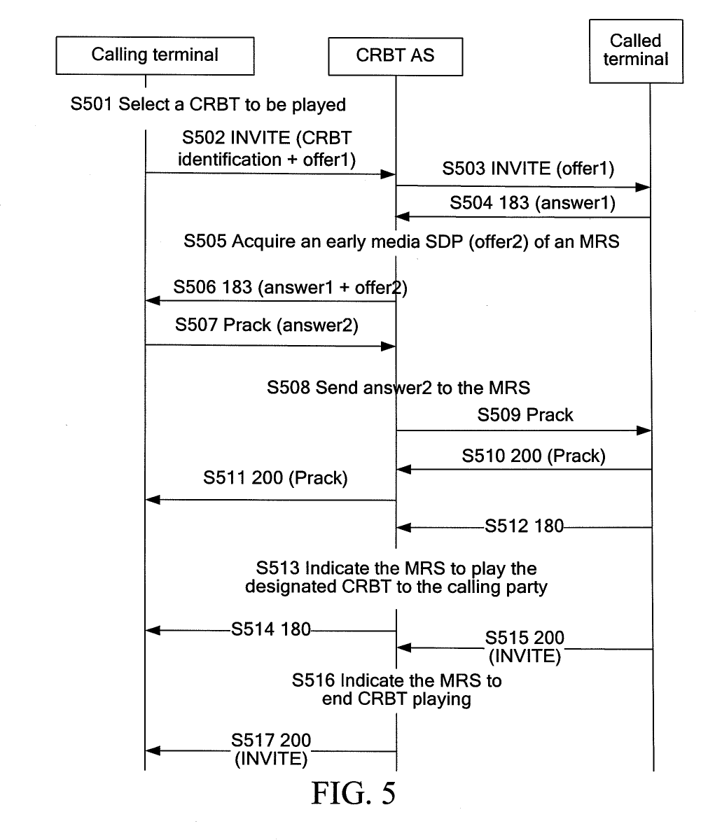

FIG. 5 is a flow chart of a method for selecting and playing an IMS CRBT according to an embodiment of the present invention. The method specifically includes the following steps.

In Step S501, before initiating a call, a calling terminal selects a CRBT to be played in the present call from a CRBT list in CRBT service information set by a called user for a calling user and all other contacts. The CRBT service information may also be CRBT service information set by the called user for the calling user individually.

In Step S502, the calling terminal initiates a call request to a called terminal. The call request carries a normal media Session Description Protocol (SDP) (offer1) for establishing calls and an identification of the CRBT selected by the calling user. A CRBT identification may be a CRBT number, a uniform resource identifier (URI), or a CRBT name, as long as it can uniquely identify a CRBT in a certain range.

The CRBT identification may specifically be carried in a call-info header field, as shown in the following:

<http://www.example.com/sounds/moo.wav>.

To facilitate the parsing of a CRBT service platform, a value of a “purpose” parameter may also be extended to designate the function of a URI carried in the header field, for example, purpose =CMRT is defined, as shown in the following:

<http://www.example.com/sounds/moo.wav>; purpose=CMRT

In Steps S503-S511, conversation media negotiation and CRBT media negotiation are performed.

An CRBT application server (AS) sends the call request to the called terminal, the called terminal performs normal media negotiation according to the own capabilities, carries a normal media SDP (answer1) negotiated by the calling and called parties in a temporary response message and sends the temporary response message to the calling terminal through the CRBT AS. The response message may be 183 signaling.

The CRBT AS acquires and sends an early media SDP (offer2) of a media resource server (MRS) to the calling terminal to perform CRBT media negotiation, and then sends a negotiated CRBT SDP (answer2) to the MRS.

In Steps S512-S514, after receiving ringing signaling 180 sent from the called terminal, the CRBT AS instructs the MRS to play the CRBT to the calling terminal and forwards the 180 signaling to the calling terminal.

The CRBT AS parses a received Invite, determines that the URI carried in the call-info header field is configured to designate the CRBT to be played according to the purpose parameter value (CMRT), and then determines the CRBT to be played according to the URI and instructs the MRS to play the CRBT to the calling party. The CRBT AS may further determine whether the CRBT media is a CRBT that has been purchased by the called terminal before instructing the MRS to play the CRBT.

If the Invite does not designate the CRBT to be played, the CRBT AS determines the CRBT to be played to the calling terminal according to a CRBT playing policy in the CRBT service information set by the called terminal and instructs the MRS to play the CRBT.

In Steps S515-S517, after receiving called party off-hook signaling 200, the CRBT AS instructs the MRS to end CRBT playing and forwards the 200 signaling to the calling terminal.

A structure of a system according to an embodiment of the present invention includes a terminal 1, a CAB server 2, and a CRBT service platform 3.

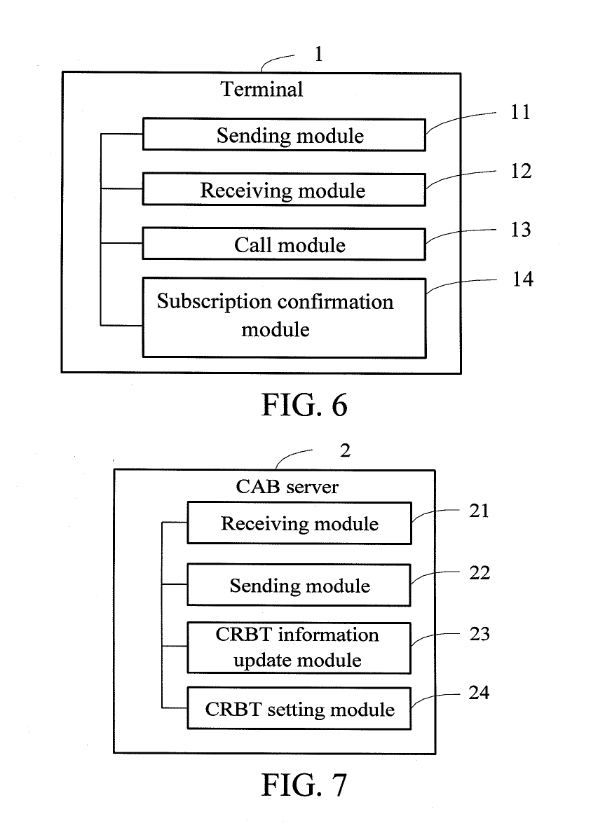

The terminal 1 (as shown in FIG. 6) includes a sending module 11, a receiving module 12, a call module 13, and a subscription confirmation module 14. The sending module 11 is configured to send a request message to the CAB server 2 to request to acquire personal information of a contact. The receiving module 12 is configured to receive the personal information of the contact sent from the CAB server 2, in which the personal information includes CRBT service information of the contact. The call module 13 is configured to initiate a call request to a terminal of the contact, in which the call request carries CRBT information selected from the CRBT service information of the contact, and the CRBT information at least includes a CRBT identification, and receive a CRBT played by the CRBT service platform 3 according to the CRBT information carried in the call request. The subscription confirmation module 14 is configured to return a subscription confirmation message to a terminal initiating a request for subscribing to the personal information of the contact.

The CAB server 2 (as shown in FIG. 7) includes a receiving module 21, a sending module 22, a CRBT information update module 23, and a CRBT setting module 24. The receiving module 21 is configured to receive a request message requesting to acquire personal information of a contact sent from the terminal 1. The sending module 22 is configured to return the personal information of the contact to the terminal 1, in which the personal information includes CRBT service information of the contact. The CRBT information update module 23 is configured to acquire the CRBT service information of the contact from the CRBT service platform 3, converge the CRBT service information into the personal information of the contact, and send the personal information of the contact to a user subscribing to the personal information of the contact. The CRBT setting module 24 is configured to receive a request message for setting or modifying a CRBT sent from the terminal 1, and send set or modified information to the CRBT service platform 3.

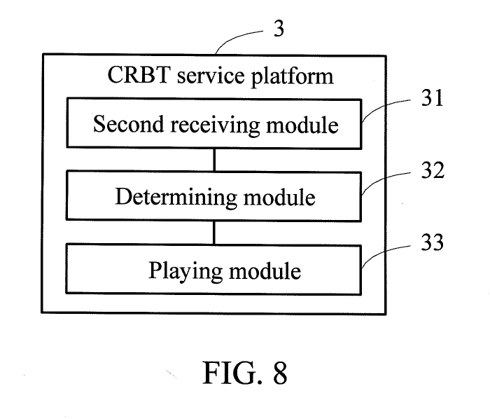

The CRBT service platform 3 (as shown in FIG. 8) includes a receiving module 31, a determining module 32, and a playing module 33. The receiving module 31 is configured to receive a call request initiated by the terminal 1. The determining module 32 is configured to determine whether the call request carries CRBT information. The playing module 33 is configured to play a CRBT to the terminal 1 according to a determination result of the determining module 32.

In the embodiments of the present invention, an interface is established between the CAB server and the CRBT service platform, so that the CAB server can acquire the CRBTs to which the users subscribe from the CRBT service platform and converge the CRBT service information into the personal information of the users. Further, the CRBTs of the CAB user for a certain contact or group can be set on the terminal of the user conveniently through the interface. The information can be shown to a contact subscribing to the personal information of the CAB user. The contact can know the CRBTs to which the user subscribes. Further, the CRBTs set for different contacts are shown to different contacts, so that the contact subscribing to the personal information of the user can know the CRBTs set by the user for the contact through the CRBT service information in the personal information. Therefore, the contact can select to hear one of the CRBTs when calling the user.

Through the above description of the implementation, it is clear to persons skilled in the art that the present invention may be accomplished through hardware, or through software plus a necessary universal hardware platform. Based on this, the technical solutions of the present invention may be embodied in the form of a software product. The software product may be stored in a nonvolatile storage media (for example, CD-ROM, USB flash drive, or removable hard disk) and contain several instructions configured to instruct a computer device (for example, a personal computer, a server, or network device) to perform the method according to the embodiments of the present invention.

To sum up, the above descriptions are merely preferred embodiments of the present invention, but not intended to limit the scope of the present invention. Any modification, equivalent replacement, and improvement made without departing from the spirit and principle of the present invention shall fall within the scope of the present invention.

1. A method for acquiring caller ring back tone (CRBT) service information of a contact, comprising:
sending a request message to an information publishing server of a contact, so as to request to acquire personal information of the contact; and
receiving the personal information of the contact sent from the information publishing server, wherein the personal information comprises CRBT service information of the contact.

2. The method according to claim 1, wherein after the receiving the personal information of the contact sent from the information publishing server, the method further comprises:
initiating a call request to a terminal of the contact, wherein the call request carries CRBT information selected from the CRBT service information, and the CRBT information at least comprises a CRBT identification; and
receiving a CRBT played by a CRBT service platform according to the CRBT information carried in the call request.

3. A method for providing color caller ring back tone (CRBT) service information of a contact, comprising:
acquiring, by an information publishing server, the CRBT service information of the contact from a CRBT service platform;
converging the CRBT service information into personal information of the contact; and
sending the personal information of the contact to a user subscribing to the personal information of the contact.

4. The method according to claim 3, further comprising:
receiving, by the information publishing server, a request message for setting or modifying a CRBT sent from a terminal, and requesting the CRBT service platform to set or modify the CRBT according to the request message.

5. The method according to claim 4, wherein the CRBT is for an individual contact or a group.

6. The method according to claim 3, wherein the CRBT service information is subscribed to by the information publishing server and the information publishing server stores updated CRBT service information.

7. The method according to claim 3, wherein the information publishing server is a Presence server or a converged address book (CAB) server.

8. A method for playing a caller ring back tone (CRBT), comprising:
receiving, by a CRBT service platform, a call request, and determining whether the call request carries CRBT information; and
playing, by the CRBT service platform, a CRBT to a terminal initiating the call request according to the CRBT information, if the call request carries the CRBT information.

9. The method according to claim 8, further comprising:
carrying the CRBT information through a call-info header field.

10. The method according to claim 9, further comprising:
designating a function of the CRBT information carried in the call-info header field through a purpose parameter.

11. A terminal, comprising:
a sending module, configured to send a request message to a converged address book (CAB) server to request to acquire personal information of a contact; and
a receiving module, configured to receive the personal information of the contact sent from the CAB server, wherein the personal information comprises color caller ring back tone (CRBT) service information of the contact.

12. The terminal according to claim 11, further comprising:
a call module, configured to initiate a call request to a terminal of the contact, wherein the call request carries CRBT information selected from the CRBT service information of the contact, and the CRBT information at least comprises a CRBT identification, and receive a CRBT played by a CRBT service platform according to the CRBT information carried in the call request.

13. A converged address book (CAB) server, comprising:
a receiving module, configured to receive a request message requesting to acquire personal information of a contact sent from a terminal; and
a sending module, configured to return the personal information of the contact to the terminal, wherein the personal information comprises caller ring back tone (CRBT) service information of the contact.

14. The server according to claim 13, further comprising:
a CRBT information update module, configured to acquire the CRBT service information of the contact from a CRBT service platform, converge the CRBT service information into the personal information of the contact, and send the personal information of the contact to a user subscribing to the personal information of the contact.

15. The server according to claim 13, further comprising:
a CRBT setting module, configured to receive a request message for setting or modifying a CRBT sent from the terminal, and send set or modified information to a CRBT service platform.

16. A caller ring back tone (CRBT) service platform, comprising:
a receiving module, configured to receive a call request initiated by a terminal;
a determining module, configured to determine whether the call request carries CRBT information; and
a playing module, configured to play a CRBT to the terminal according to a determination result of the determining module.
